(19) United States
(12) Patent Application Publication
(10) Pub. No.: US 2004/0223622 A1
(43) Pub. Date: Nov. 11, 2004

(54) Digital wireless loudspeaker system

(76) Inventors: Eric Lee Lindemann, Boulder, CO (US); John Laurence Melanson, Boulder, CO (US); Jason Lee Carlson, Boulder, CO (US); James Mitchell Kates, Niwot, CO (US)

Correspondence Address: Dan A Shifrin, Cirrus Logic Inc, 2901 Via Fortuna, Austin, TX, 78746-7574, US

(21) Appl. No.: 09/707,616

(22) Filed: Apr. 6, 2001

Related U.S. Application Data
(62) Division of application No. 09/452,904, filed on Dec. 1, 1999.

(51) Int. Cl. H04B 5/00; H04B 3/00

(52) U.S. Cl. 381/79; 381/77

(57) ABSTRACT

A digital wireless loudspeaker system includes an audio transmission device for selecting and transmitting digital audio data, and wireless speakers for receiving the data and broadcasting sound. The audio transmission device selects digital audio data together with a sample clock from a stereo compact disk, or decoded DVD data. The sample clock clocks an element that generates frames of data and adds error protection. Status messages are included in the transmission frames to control speaker attributes such as speaker group, enabling or disabling a sub-woofer, and volume of the loudspeaker digitally. These transmission frames are clocked into an RF transmitter and transmitted to the speakers. The received bit stream and symbol clock are output from the RF receiver in each speaker and input to a framing and error protection decoder and a sample clock generator. The recovered audio sample data and sample clock are input to a digital to speaker input conversion and channel selector.

This application claims the benefit of U.S. patent application Ser. No. 09/452,904 filed, Dec. 1, 1999

### BACKGROUND OF INVENTION

1. Field of the Invention

This invention relates to digital wireless loudspeaker systems.

2. Description of the Prior Art

Traditionally wires are required to connect an audio source, such as the output of a hi-fi power amplifier, to a set of loudspeakers. These wires are inconvenient, since they often need to be run under carpeting and floors, and through walls and ceilings. As home theater systems, often involving six surround sound loudspeakers, become increasingly popular, the wiring problem becomes a major annoyance.

Wireless loudspeakers that communicate with the audio source via RF transmission remove the need for this web of wires.

Wireless loudspeakers have existed for some time [Recoton Patent Reference]. The analog FM transmission systems used in these speakers have resulted in relatively low-fidelity systems with signal to noise ratios on the order of 40 dB to 60 dB. A need exists for a high Patent Reference]. The analog FM transmission systems used in these speakers have resulted in relatively low-fidelity systems with signal to noise ratios on the order of 40 dB to 60 dB. A need exists for a high fidelity wireless loudspeaker system with performance on a par with wired solutions.

The sampling rate of a compact disk is 44100 16 bit samples/second. This results in a bit rate for stereo of 44100*16*2=1411200 bits/second. To achieve reliable wireless transmission, redundancy must be introduced in the transmitted bit stream. This redundancy supports a robust error detection and correction system. In addition, the wireless transmission system requires additional bits for framing and synchronization of data. In all, approximately three times the original bit rate, or 3*1,411200=4,233,600 bits/second, is required to support wireless stereo. For a six channel surround sound home theater system, the bit rate triples to 3*4,233,600=12,700,800 bits/sec. Achieving these bit rates can be extremely difficult.

A wireless loudspeaker requires a power amplifier local to the loudspeaker. Local power amplifiers can provide an advantage in terms of audio fidelity. Most loudspeakers are either two-way or three-way systems. This means that the audio signal is divided into two or three frequency bands and these bands are sent to specialized speakers—woofer, tweeter, mid-range. The typical consumer audio loudspeaker divides the amplified audio signal into frequency bands using passive crossover circuits in the loudspeaker. These passive crossover circuits are made of inductors, resistors, and capacitors. The passive crossovers are difficult to design and are a major source of frequency distortion in a loudspeaker system.

An alternative to passive crossovers is active crossovers. With active crossovers, the line level unamplified audio signal is divided into frequency bands and then each frequency band signal is sent to a separate power amplifier. In a two-way system this is called bi-amplification. In a three-way system this is called tri-amplification. Active crossovers have traditionally been designed using analog electronics—op-amps etc. While active crossovers with multiple power amplifiers provide a clear benefit in terms of audio fidelity they can be a challenge to design cost effectively.

### SUMMARY OF INVENTION

An digital wireless loudspeaker system includes an audio transmission device for selecting and transmitting digital audio data and wireless speakers for receiving the data and broadcasting sound. Digital audio data together with a digital audio sample clock that synchronizes the data, comes to the audio transmission device from either a stereo compact disk or an AC-3 or MPEG-2 Audio Decoder that decodes and uncompresses the multichannel compressed audio stream coming from the DVD motion picture disk. In the audio transmission device, a selector element selects the data and clock coming from either the CD Player or the Audio Decoder. The selected sample clock is used to clock the selected data into a framing and error protection encoding unit which generates frames of data and adds error protection. These transmission frames are clocked into an RF transmitter and transmitted to the speakers. For a stereo system there are two loudspeakers. For a typical surround sound home theater system there are six loudspeakers. Each loudspeaker contains an RF receive antenna and an RF receiver, and performs acquisition and tracking on the RF signal generated by the single RF transmitter in the audio transmission device. The received bit stream and symbol clock are output from the RF receiver and input to a framing and error protection decoder and a sample clock generator. The recovered audio sample data and audio sample clock are input to a digital to speaker input conversion and channel selector. Status messages are included in the transmission frames to control speaker attributes such as speaker group, enabling or disabling a sub-woofer, and volume of the loudspeaker digitally.

Wireless transmission of digital audio is used in this invention to achieve hi-fidelity performance comparable to compact disk quality audio. One embodiment of the present invention solves this problem by using digital crossovers on the uncompressed digital audio signal and then employs novel Class D pulse width modulation (PWM) power amplifiers. These Class D PWM amplifiers are inexpensive and provide a convenient low cost path for generating an amplified speaker input signal directly from the digital audio stream.

When digital audio is transmitted to a wireless speaker the speaker needs to reliably recover the data as a stream of digital audio samples and needs to generate an accurate digital audio sample rate clock to output the data. When transmitting to several wireless loudspeakers simultaneously, as is the case with stereo or six channel surround sound, the sample rate clocks for the loudspeakers must be accurately synchronized to the data and with each other. Small delays from one speaker to the next would compromise the stereo or surround sound imaging of the sound. Even worse, variable delays would cause sounds to appear to move around in space. This invention solves the audio sample rate synchronization problem by generating the audio sample rate clock directly from the RF receiver symbol rate clock. For an RF system with continuously streaming data transmission, as is the case with digital audio in this invention, this clock is highly accurate and is guaranteed to be synchronized between RF receivers in multiple loudspeakers because it is generated at a single location in the RF transmitter.

One embodiment of the present invention meets the bit rate requirements by transmitting multichannel digitally compressed audio. Each loudspeaker receives the entire multichannel RF compressed audio stream, uncompresses it, and in the process selects the single channel intended for that loudspeaker.

### BRIEF DESCRIPTION OF THE DRAWINGS

FIG. 1 shows a block diagram of the audio part of a home theater system according to the present invention.

FIG. 2 shows a block diagram of second embodiment of the present invention.

FIG. 3 shows a detailed block diagram of the RF Receiver of FIG. 1.

FIG. 4 shows a detailed block diagram of the RF Transmitter of FIG. 1.

FIG. 5 shows a detailed block diagram of the Framing and Error Protection Encoding unit of FIG. 1.

FIG. 6 shows a block diagram of the Framing and Error Protection Encoding unit of FIG. 2.

FIG. 7 shows the diverse antenna of FIG. 3 in more detail.

FIG. 8 shows a block diagram of the Framing and Error Protection Decoder and Sample Clock Generator of FIG. 1.

FIG. 9 shows a block diagram of the Framing and Error Protection Decoder and Clock Generator of FIG. 2.

FIG. 10 shows a block diagram of one embodiment of the Speaker Input Conversion and Channel Selector of FIG. 1.

FIG. 11 shows another embodiment of the Digital to Speaker Input Conversion and Channel Selector of FIG. 1

FIG. 12 shows a block diagram of the Digital to Speaker Input Conversion and Compressed Audio Decoder and Channel Selector unit of FIG. 2.

FIG. 13 shows another embodiment of the Digital to Speaker Input Conversion and Compressed Audio Decoder and Channel Selector unit of FIG. 2.

FIG. 14 shows one embodiment of a single channel of the Stereo Digital Audio Encoder of FIG. 2.

FIG. 15 shows a third embodiment of the current invention.

FIG. 16 shows one embodiment of the RF Receiver used in the embodiment of FIG. 15.

FIG. 17 shows another embodiment of the RF Receiver used in embodiment of FIG. 15.

FIG. 18 shows one embodiment of the Channel Selection Interface of FIG. 15.

FIG. 19 shows a second embodiment of the Channel Selector Interface of FIG. 15.

### DETAILED DESCRIPTION OF PREFERRED EMBODIMENTS

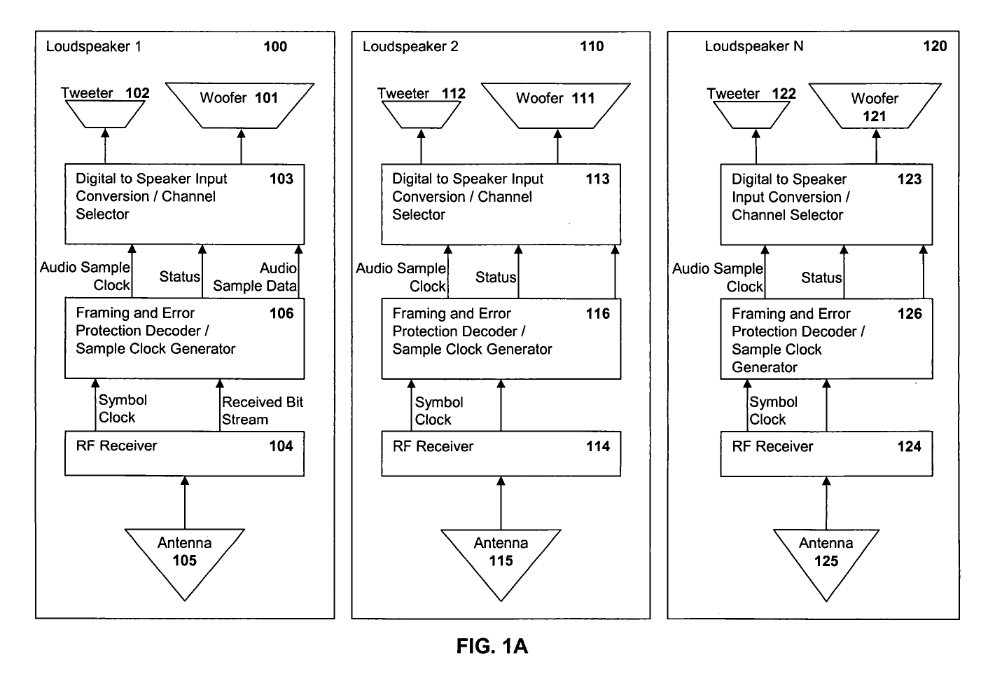

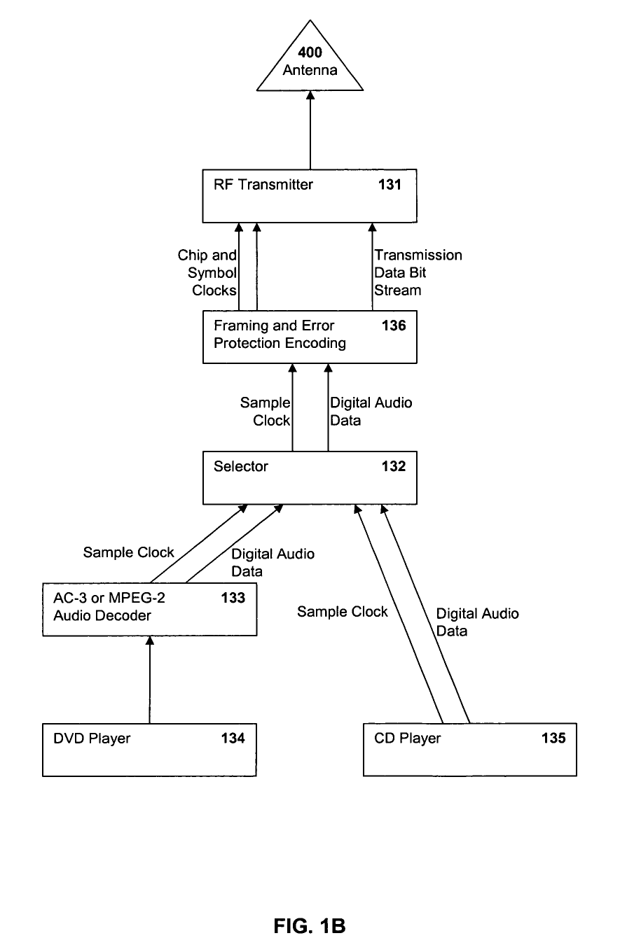

FIG. 1 shows a block diagram of the audio part of a home theater system in which the present invention is used. Digital Audio Data together with a digital audio Sample Clock that synchronizes the data, comes from either a stereo compact disk 135, or the AC-3 or MPEG-2 Audio Decoder 133 that decodes and uncompresses the multichannel compressed audio stream coming from the DVD motion picture disk 134. Audio from the DVD disk is encoded in a compressed multichannel format—generally either AC-3 six channel or MPEG-2 multichannel formats. The Selector 132 selects the Digital Audio Data and Sample Clock coming from either the CD Player 135 or the AC-3 or MPEG-2 Audio Decoder 133. The selected Sample Clock is used to clock the selected Digital Audio Data into the Framing and Error Protection Encoding unit 136.

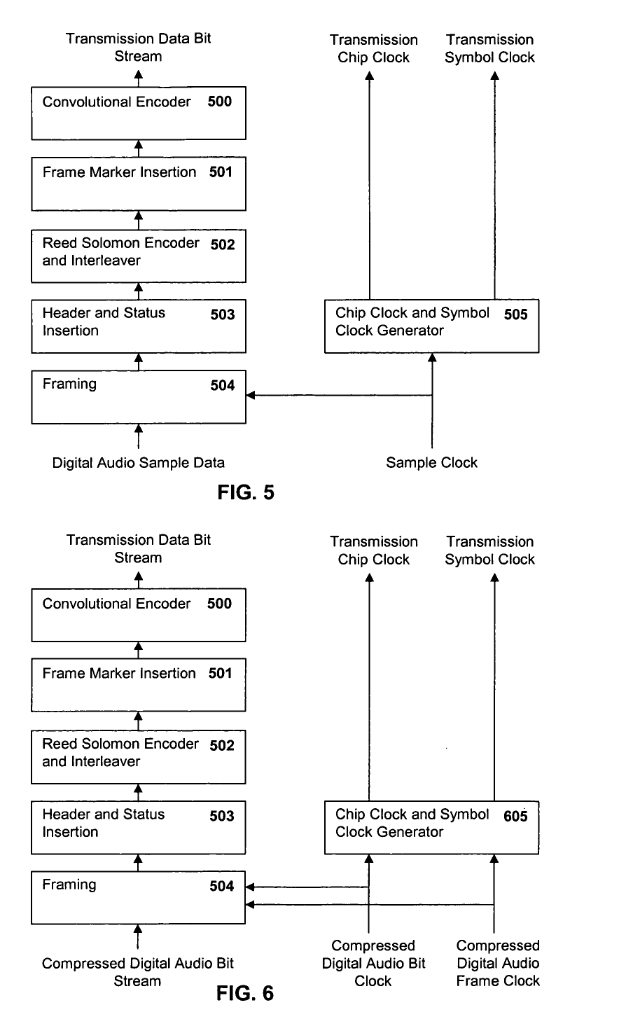

A detailed block diagram of the Framing and Error Protection Encoding unit is shown in FIG. 5. The Framing unit 504 assembles Digital Audio Frames consisting of a fixed number of digital audio samples. Header and status information is added to each Digital Audio Frame 503. The function of the status information is to transmit various loudspeaker settings and configurations to the loudspeaker systems. The Reed Solomon Encoder and Interleaver 502 divides the Digital Audio Frames into smaller Transmission Frames with a fixed number—e.g. 4—of Transmission Frames per Digital Audio Frame. The interleaving function of the Reed Solomon Encoder and Interleaver 502 shuffles the bits in one digital audio frame so that adjacent digital audio bits appear in different Transmission Frames. Interleaving protects against burst errors in transmission. Each Transmission Frame is Reed Solomon Encoded 502 for error protection, and then a fixed bit sequence Frame Marker pattern is inserted in front of each Transmission Frame 501. The Frame Marker is used by the RF Receiver to recognize Transmission Frame boundaries. The Transmission Frame with inserted Frame Marker is then Convolutionally Encoded 500 for added error protection. The combination of Reed Solomon Encoding and Convolutional Encoding is called a concatenated encoder and represents a particularly robust form of encoding for error protection.

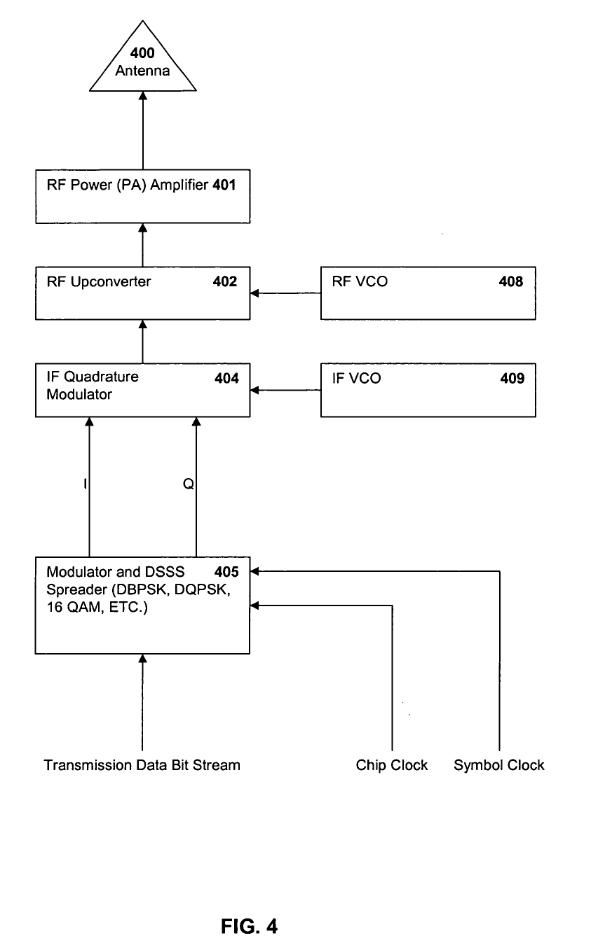

In FIG. 1 the Transmission Frames from the Framing and Error Protection Encoding unit 136 are clocked into the RF Transmitter 131. FIG. 4 shows a detailed block diagram of the RF Transmitter. In the embodiment of FIG. 4, the Transmission Frames output from 136 form a bit stream that is input to the Modulator and Direct Sequence Spread Spectrum (DSSS) Spreader 405. The Modulator and DSSS Spreader 405 takes the input bit stream M bits at a time and generates M-ary symbols. The symbols are generated at the Symbol Rate which is equal to the input bit rate divided by M. M is the number of bits per symbol and is typically in the range 2 to 16. The symbols are modulated by a spreading sequence. The spreading sequence is S bits long and the clock rate of the spreading sequence modulation, called the Chip Rate, is S times the symbol rate. S is typically in the range 10 to 16.

The Modulator and Direct Sequence Spread Spectrum (DSSS) Spreader 405 relies on a Chip Clock and Symbol Clock. The Chip and Symbol Clocks are generated in the Framing and Error Protection Encoding unit 136, shown in detail in FIG. 5. Each Digital Audio Frame, corresponds to a fixed number of multichannel audio samples. After header, status, and error bits are added to generate an extended digital audio frame, and after this extended frame is divided into transmission frames, each of which has error protection bits and a frame marker added to it, there are then a fixed number encoded transmission bits associated with each Digital Audio Frame. Since there are M transmission bits per transmission symbol we are able to derive a fixed ratio between the audio sample clock and the symbol and chip rate clocks.

Fc=S*Fs

Fs=Fa*Sf/Af

where:

Fc=frequency of chip rate clock

S=number of chips per symbol

Fs=frequency of symbol clock

Fa=frequency of audio sample clock

Af=number of multichannel audio samples per digital audio frame

Sf=(Tf*Bf/M)=number of symbols per digital audio frame

Tf=number of transmission frames per digital audio frame—a constant

Bf=number of data bits per transmission frame—a constant

M=number of data bits per symbol—a constant

The chip clock is then a fixed integer ratio Fc=Fa*(S*Sf/Af) of the audio sample clock. The precise value of Fc is chosen so that (S*Sf/Af) can be expressed as a ratio of relatively small integers R/Q. Taking the audio sample clock as input, and using frequency multipliers and clock dividers the Chip Clock and Symbol Clock Generator 505 in FIG. 5 is generates a Chip and Symbol Clock, based on multiplying the audio sample clock by R/Q. These clocks are tightly synchronized with the audio Sample Clock. Frequency multipliers and clock dividers are well understood by those skilled in the art of digital circuit design. In FIG. 1 the encoded frames from the Framing and Error Protection Encoding unit 136 are clocked into the RF Transmitter 131 using the Symbol Clock and Frame Clock.

In another embodiment both the Chip Clock and Symbol Clock and the Sample Clock are generated by frequency multiplication and clock division from the same Clock Oscillator running from the same crystal or. In general this oscillator run at a high frequency so that only clock dividers are required to generate both the Symbol Clock, Chip Clock, and audio Sample Clock.

The interleave function performed by the Reed Solomon Encoder and Interleaver with Frame Marker Insertion 407 protects against burst errors by scrambling adjacent bits across multiple Reed Solomon encoding blocks. This error protection system is a called a concatenated encoder with interleaving and is well known to those skilled in the art of error protection system design [Error Control Coding: Fundamental and Applications, Lin and Costello, Prentice Hall, 1983].

Every digital RF modulation scheme, be it DSSS, FHSS, or another non-spread spectrum scheme, requires an accurate method of determining the symbol rate. A key element of the present invention is that the symbol rate is a fixed ratio R/Q of the audio Sample Clock. In other embodiments it may not be necessary to explicitly generate an actual Symbol Clock signal to accomplish the same goal of generating the symbol rate as a fixed ratio R/Q of the audio Sample Clock. In DSSS a chip clock is used which is S time the symbol rate. In FHSS no chip clock is used so only the symbol clock or symbol rate reference is generated.

Many DSSS modulation schemes exist and are well known to those skilled in the art of RF system design [Digital Communications, Fundamentals and Applications, Benard Sklar, Prentice Hall, 1988]. Also, many error encoding and modulation schemes can be implemented. In particular a Frequency Hopping Spread Spectrum (FHSS) modulation scheme [Digital Communications, Fundamentals and Applications, Benard Sklar, Prentice Hall, 1988] is a well known common alternative to a DSSS modulation scheme. In addition, it may be possible in certain situations to use a less complex error protection scheme consisting of a Convolutional Encoder alone, a Reed Solomon Encoder alone, or even no error protection scheme at all. In the absence of a Reed Solomon Encoder a separate Scrambler is often used to provide the same kind of protection against burst errors. Also, in the absence of a Reed Solomon Encoder a separate Frame Marker Insertion Unit inserts a Frame Marker every N audio samples. This allows the RF Receiver to recognize the beginning of a block of audio samples in an otherwise continuous bit stream. It is obvious to one skilled in the art of RF System design that the particular embodiment of RF Transmitter does not change the character of the present invention.

The output of the Modulator and DSSS Spreader 405 is a complex signal with I and Q—real and imaginary—components. I and Q are input to the IF Quadrature Modulator 404 where they are modulated by intermediate frequency (IF)—typically 50 to 200 MHz—sine and cosine modulators. The sine and cosine modulators are derived from the IF VCO 409 output. The modulated I and Q are summed and this summed IF output is sent to the RF Upconverter 402. The RF Upconverter 402 modulates the IF output by a sinusoid at the RF carrier frequency—915 MHz, 1.4 GHz, etc.—which is generated by the RF VCO 408. The RF frequency signal is input to the Power Amplifier 401 and the amplified RF frequency signal is output to the air through the RF transmitter antenna 400. Some details such as band pass and low pass filters are left out of the block diagram of FIG. 4. Those skilled in the art of RF System design will recognize this and understand that only the principle blocks of the RF transmitter design are shown in FIG. 4.

FIG. 1 shows Loudspeaker One 100, Loudspeaker Two 110 and Loudspeaker N 120. For a stereo system there are two loudspeakers. For a typical surround sound home theater system there are six loudspeakers. It is clear to one skilled in the art that the present invention can accommodate any reasonable number of loudspeakers with N typically equal to 2 through 8.

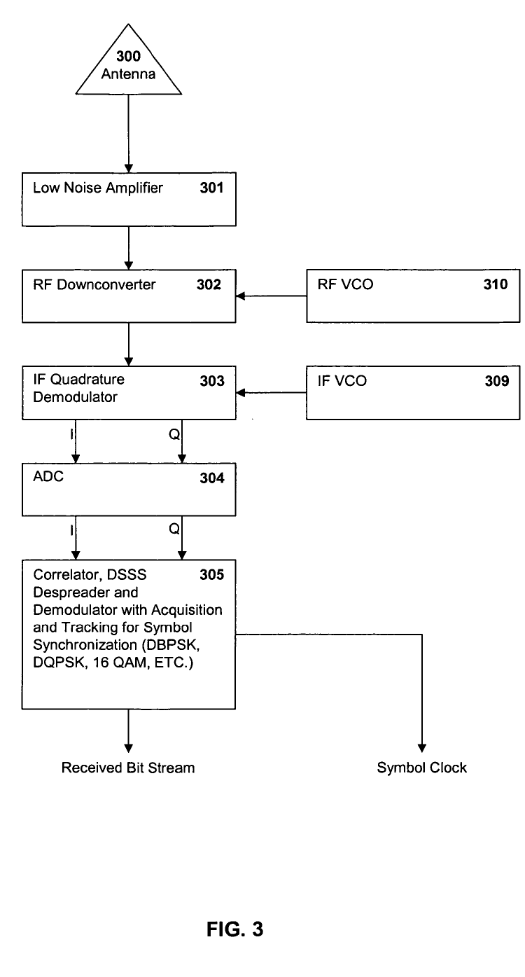

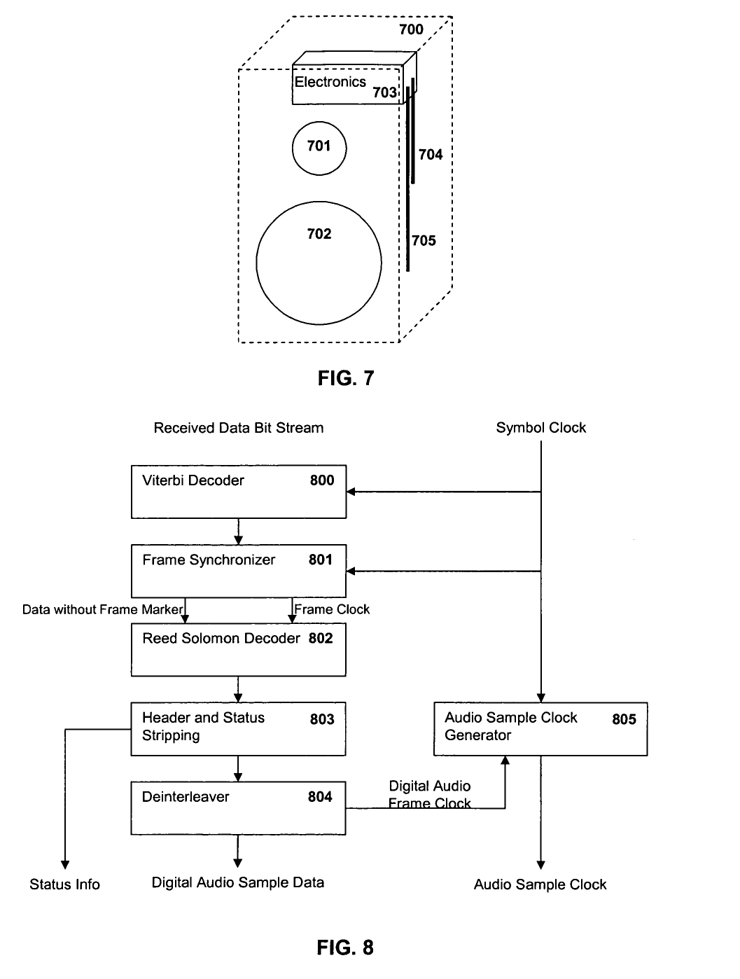

Each loudspeaker contains an RF receive antenna 105,115,125 and an RF receiver 104,114,124. One embodiment of the RF Antenna and RF receiver is shown in FIG. 3. In this embodiment the receive antennae 300 found in each loudspeaker is comprised of multiple antennae of different sizes. This diverse antenna is shown in FIG. 7. The multiple antennae of FIG. 7 are housed in the speaker cabinet 700. 704 is the short antenna and 705 is a longer antenna. These antennae connect to the Electronics unit 703 which is also found inside the speaker cabinet 700 along with the Tweeter 701 and Woofer 702 speakers. The Electronics unit 703 contains all of the electronics for RF communications, audio signal processing, audio decoding, and amplification. The diverse antenna sizes allow for more robust RF reception, especially in the presence of multipath transmission due to reflections from walls, floors, ceilings, moving bodies, furniture, and other obstacles commonly found in indoor environments.

A detailed block diagram of the RF Receiver is shown in FIG. 3. This embodiment implements a Direct Sequence Spread Spectrum (DSSS) demodulator and a concatenated error protection decoder corresponding to the RF transmitter embodiment of FIG. 4. It is obvious to one skilled in the art of RF system design that the RF receiver design must mirror the RF transmitter design in its overall structure. In particular if an FHSS modulator is used in the transmitter an FHSS demodulator must be used in the receiver. Likewise, if an error protection encoder other than the concatenated encoder described in the RF transmitter embodiment of FIG. 4 is used, then the corresponding error protection decoder must be used in the RF receiver. It is obvious to one skilled in the art of RF transmitter and receiver design that many variations of modulation/demodulation and error protection encoding and decoding can be used without altering the character of the present invention.

In the RF receiver embodiment of FIG. 3, the RF frequency signal from the antenna 300 is input to the RF Low Noise Amplifier 301 whose output is sent to the RF Downconverter 302. The RF Downconverter 302 modulates the RF signal, using a sinusoid generated by the RF VCO 310, down to IF frequency. Some details such as band pass and low pass filters are left out of the block diagram of FIG. 3. Those skilled in the art of RF System design will recognize this and understand that only the principle blocks of the RF receiver design are shown in FIG. 3. The IF signal is further down modulated by the IF Demodulator 303. The output of the IF Demodulator is a complex signal consisting of I and Q—real, imaginary—running at the Chip Rate. The I and Q components are input to an Analog to Digital Converter (ADC) 304 with sampling rate typically 1-2 times the Chip Rate. The ADC precision is typically 3 to 4 bits for I, and 3 to 4 bits for Q. In order to successfully decode the received 1 and 0 signals, they must be despread. This is accomplished by again multiplying I and Q with the same spreading sequence used in the Modulator and DSSS Spreader 405 of the RF transmitter. This spreading sequence is known in advance. The spreading sequence must be correctly aligned in time with the received I and Q signals. This process is called symbol synchronization and is generally accomplished in two stages: a course synchronization stage called acquisition, and a fine tuning synchronization stage called tracking. Synchronization is implemented by the Correlator, DSSS Despreader and Demodulator with Acquisition and Tracking for Symbol Synchronization 305. Separate despreaders and correlators are used for the I and Q components. The correlators multiply the input I and Q signals with the spreading sequence. The multiply and sum operation of the correlators is done at a series of different delays with respect to the input I and Q signals. The intention is to find the delay with the maximum correlation value. At this delay the input I and Q signals are roughly synchronized with the Symbol Rate of the transmitter. The corresponds to the output of the acquisition stage of symbol synchronization. The symbol synchronization is further fine tuned by a tracking stage. Several techniques for tracking are known in the art. These include Delay-Locked Loop (DLL) and Tau-Dither Loop techniques. [Digital Communications, Fundamentals and Applications, Benard Sklar, Prentice Hall, 1988]. Acquisition and tracking allow the start of the symbol period to be known with excellent sub-chip period resolution. At the start of each symbol period, as determined by the acquisition and tracking stages, the Correlator, DSSS Despreader and Demodulator with Acquisition and Tracking for Symbol Synchronization 305 outputs a pulse. This stream of pulses, once per symbol, is the Symbol Clock. Similar acquisition and tracking techniques are used to perform Symbol Synchronization in FHSS systems and, in fact, in every other Digital RF Transmission system. Symbol synchronization techniques are well known to those skilled in the art of RF Receiver design and it is obvious to such a practitioner that the particular type of Symbol Synchronization employed will not change the character of the present invention.

In the present invention several loudspeakers each perform acquisition and tracking on the RF Signal generated by the single RF Transmitter. As a result the output of 305 in the RF Receiver of each loudspeaker is a Symbol Clock synchronized, to within sub-chip resolution, with the Symbol Clock in every other loudspeaker in the system. In the present invention, the transmitter transmits digital audio bits at a continuous and constant Symbol Rate derived directly from the digital audio Sample Clock that clocks audio samples into the RF Transmitter. This constant transmission rate results in a constant Symbol Clock output from 305.

In FIG. 1 we see that the received bit stream and Symbol Clock are output from the RF Receiver and input to the Framing and Error Protection Decoder and Sample Clock Generator 106,116,126. A block diagram of the Framing and Error Protection Decoder and Sample Clock Generator is shown in FIG. 8. The received bit stream is input to the Viterbi Decoder 800 which performs error detection and correction corresponding to the Convolutional Encoder 500 of FIG. 5. The Viterbi decoded bit stream is input to the Frame Synchronizer 801.

Since the transmitted audio stream is continuous and constant the Frame Marker at the beginning of each Transmission Frame appears in the received bit stream at constant time intervals. The Frame Synchronizer 801 correlates the known Frame Marker sequence across many frame periods, and by so doing is able to determine the location of the Frame Marker and hence the start of each Transmission Frame. This is a convenient and economical method for frame synchronization. Another less economical methods is sync word recognition at each frame boundary. Several techniques for frame synchronization are known in the art of RF Receiver Design [Digital Communications, Fundamentals and Applications, Benard Sklar, Prentice Hall, 1988]. It is obvious to one skilled in the art of RF Receiver design that the exact method of frame synchronization chosen does not effect the character of the present invention.

By reading the start each Transmission Frame the RF Receiver is able determine which Transmission Frame contains the Digital Audio Frame header, and as a result is able to identify the start of each Digital Audio Frame. The Frame Synchronizer 801 also strips off the Frame Marker and passes the Transmission Frames on to the Reed Solomon Decoder 802. Each transmission frame is Reed Solomon Decoded to generate fully error corrected Transmission Frames. The Transmission Frames are passed on to the Header and Status Stripper 803 which reads the head of each Transmission Frame looking for the header and status information that marks the beginning of each Digital Audio Frame. The Header and Status Stripper 803 removes the header and status information passing on the status information to the rest of the system. The digital audio data is passed on the Deinterleaver 804, which unshuffles the data in a single Digital Audio Data Frame to yield the original Digital Audio Data Frame. The Deinterleaver 804 also generates a pulse corresponding to the Digital Audio Frame Clock.

The Symbol Clock and the Digital Audio Frame Clock are input to the Audio Sample Clock Generator 805. Since we know that the ratio of transmission symbols to audio samples per Digital Audio frame is equal to R/Q, as described above, then by using frequency multipliers and clock dividers the Audio Sample Clock Generator is able to regenerate the Sample Clock by multiplying the Symbol Clock by Q/R. Since the Digital Audio Frame clock marks the beginning, with Symbol Clock accuracy, of a block of digital audio samples, it can be used to accurately set the phase of the regenerated Sample Clock. The Sample Clock is thus regenerated to within the synchronization limits of the Symbol Clock. This is approximately plus or minus one half the chip period. Given a symbol size of 2 bits, such as with DQPSK modulation, a factor of three redundancy in the data, stereo 16 bit samples, and a chip rate 11 times the symbol rate we have (16 bits/per sample*2 samples/per stereo sample*3 redundancy/2 bits per symbol*11 chips per symbol=528 chips per sample. So the Sample Clock is synchronized across all loudspeakers at +−1/(2*528)=1/1056 of 1 sample for stereo. For a stereo 44,100 sampling rate this results in an audio Sample Clock synchronization between loudspeakers of +−21 nanoseconds. For six channel the synchronization is even tighter.

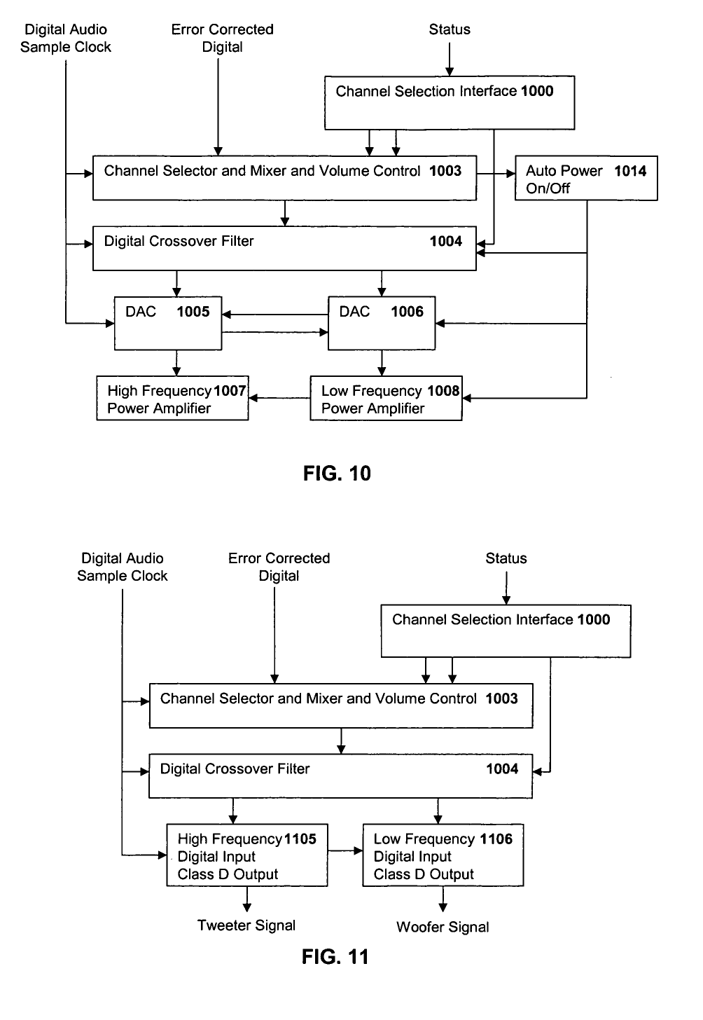

As shown in FIG. 1, the recovered Audio Sample Data and Audio Sample Clock are input to the Digital to Speaker Input Conversion and Channel Selector 103,113,123. A block diagram of one embodiment of the Speaker Input Conversion and Channel Selector is shown in FIG. 10. The Digital Audio Sample Data input to FIG. 10 consists of all channels of audio.

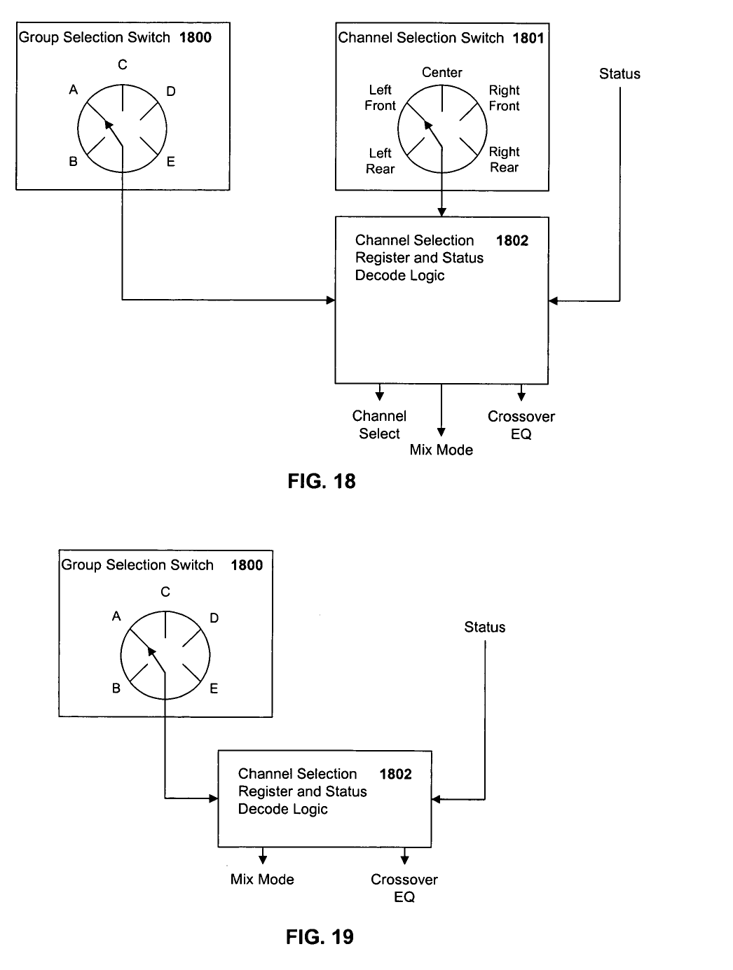

The output of the Channel Selection Interface 1000 determines which audio channel the individual loudspeaker is assigned to in a surround sound or stereo system, which mix mode to use (described later), and digital crossover filter EQ information (also described later). FIG. 18 shows one embodiment of the Channel Selection Interface. A Channel Selection Switch 1801 located on the speaker cabinet allows the user to specify what role an individual speaker is assigned to in a surround sound system: left front, center front, right front, left read, right rear. In the case of subwoofer the speaker itself is sufficiently distinctive that know switch is necessary. The output of the Channel Selection Switch is input to the Channel Selection Register and Status Decode Logic 1802. The output of the Channel Selection Register and Status Decode Logic 1802 is the output of the Channel Selection Interface 1000 and is sent to the remaining functional units of the Digital to Speaker Input Conversion and Channel Selector. A special NO_CHANNEL output code from the Channel Selection Interface specifies that the speaker is disabled and should respond to no channel selection. Also comprised in the Channel Selection Interface is a Group Selection Switch 1800. Many homes and offices have multiple groups of loudspeakers—e.g. a group of loudspeakers in the living room and another group in the kitchen. The Group Selection Switch allows a loudspeaker to be assigned to one of many groups of loudspeakers.

Status information from the Framing and Error Protection Decoder and Sample Clock Generator 106,116,126 of FIG. 1) is also received by the Channel Selection Interface 1000 and input to the Channel Selection Register and Status Decode Logic 1802. Among other messages, the status information contains commands to enable or disable a particular group of speakers. When the group to which the current loudspeaker is assigned is disabled, the Channel Selection Register and Status Decoder Logic 1802 is set to output the special NO_CHANNEL output code.

Another status message determines enabling of different speaker modes according to speaker group. For example, “enable only left and right front channels for stereo speaker Group A”. Another useful status message is “enable left and right front channels of speaker Group B to mix down the received six channel surround data to two channel stereo”. This would be appropriate if there were only two stereo speakers in speaker Group B. This mix information appears at the output of the Channel Selection Register and Status Decode Logic 1802, and is input to the Channel Selector and Mixer and Volume Control (1003 of FIG. 10). At the same time another status message can be sent saying “enable full six channel decode on Group B”. This would be appropriate if Speaker Group A consists of a full complement of six surround sound speakers. Again the mix information is used in this case.

Another status message involves enabling or disabling a sub-woofer in either a stereo or surround sound configuration. This is used to affect the frequency response of the crossover units as described below. The frequency response selection information is also available at the output of the Channel Selection Interface 1000.

Another status message involves setting the volume of the loudspeaker digitally. This message is decoded by the Channel Selection Register and Status Decode Logic (1802 of FIG. 18) and output by the Channel Selection Interface. The message includes the desired value of the volume control. The Channel Selector and Mixer and Volume Control unit 1003 receives the volume information and multiplies the incoming digital sample stream by the desired volume value. Implementing the volume control in the loudspeaker allows the RF communication link to function with a lower dynamic range equal to that coming from the media—e.g. Compact Disk or DVD. In another embodiment the Volume Control is implemented in the digital crossover filter. It obvious to one skilled in the art of digital signal processing that the volume control function can be implemented in any of the digital audio processing blocks of FIG. 10 without changing the character of the invention. The key element of the present invention is that the volume control is implemented in the loudspeaker permitting a reduced dynamic range in the RF transmission system.

It is obvious that minor changes can be made in the structure of the Channel Selection Interface, and that many variations are possible without changing the character of the current invention. A key element of the present invention is that status information is transmitted via the RF transmission system, and that this status information, possibly in conjunction with switch settings in the Channel Selection Interface, determines the enabling and disabling of a particular loudspeaker and the particular configuration of channel decoding, mixing and EQ for that loudspeaker.

The multichannel audio sample is input to the Channel Selector and Mixer and Volume Control 1003 which selects one channel from the multichannel Digital Audio Sample Data input, or mixes several channels of a surround sound signal to one channel, and outputs this to the Digital Crossover Filter 1004. In the embodiment shown in FIG. 1 a two way loudspeaker system is used, and so, the Digital Crossover 1004 divides the digital audio signal into a low and high frequency output. In another embodiment a three or four way system is used and the digital crossover divides the digital audio signal into three or four bands. There are a number of advantages to using digital filtering for implementing the crossover function. With digital filtering accurate linear phase filters can be designed. In addition the digital filters can be made to compensate for the non ideal phase and magnitude frequency characteristics of the speakers themselves. In addition the digital filter coefficients for the Digital Crossover 1004 can be downloaded to the loudspeaker using the status information which is decoded and output by the Channel Selection Interface 1000. These coefficients can be specially adjusted to compensate for acoustic differences in the room that the loudspeakers are placed in or can be adjusted according to whether or not a sub-woofer is present in the system. Different size and shapes of rooms and the locations of loudspeakers placed in them result in different, and often undesirable, changes in frequency response for a loudspeaker system. These can be almost eliminated using by using downloadable filter coefficients for the Digital Crossover 1004. The low and high frequency digital signals output from the Digital Crossover 1004 are input to two digital to analog converters (DACs) 1005,1006. The analog outputs of the DACs 1005,1006 are input to a Low Frequency Power Amplifier 1008 that drives the Woofer (101,111,121 in FIG. 1), and a High Frequency Power Amplifier 1007 that drives the Tweeter (102,112,122 in FIG. 1).

In addition to selecting the desired audio channel, the Channel Selector 1003 also determines the presence of the appropriate channel. The Channel Selector 1004 generates a power on/off binary signal in response to the presence or absence of the selected channel signal. The Auto Power On/Off unit 1014 conditions this signal and passes it on to the rest of the functions in the Speaker Input Conversion and Channel Selector of FIG. 10. In this way, only in the presence of a desired signal are the important power consuming units, such as the power amplifiers in Loudspeaker, powered up. The RF Receiver in this embodiment is always powered up. In another embodiment, the RF Receiver also receives the signal from the Auto Power On/Off circuit. When power is off the Receiver turns on periodically—e.g. 2 times a second—and briefly samples the input RF stream to determine the presence of a desired signal. When the desired signal is present the Auto Power On/Off signal changes to the on state, and the RF Receiver switches to full on mode of operation. This embodiment is even more power efficient then when the RF Receiver is left permanently in full on mode. This is appropriate for very low powered battery operation where long standby times are needed. Generally, in the present invention it is assumed that the loudspeaker is powered by plugging into a standard AC outlet, so the first Auto Power On/Off embodiment is simpler.

In another embodiment of the auto power on/off system the Channel Selector Interface generates the power on/off signal directly in response to special power on/off status messages.

Separate power amplifiers for high and low frequencies are very desirable from the point of view of audio fidelity but they add to the cost of the system. FIG. 11 shows another embodiment of the Digital to Speaker Input Conversion and Channel Selector 103,113,123 of FIG. 1. In this embodiment the DACs and Power Amplifiers have been replaced with Digital Input Class D Output amplifiers 1105,1106. These amplifiers convert the digital input stream directly to a Pulse Width Modulated (PWM) output stream that it fed directly to the speakers. This is an extremely cost effective solution. To help reduce distortion the high frequency and low frequency PWM streams are specifically adjusted for the Tweeter and Woofer they are intended to drive. The embodiment FIG. 11 has the same channel selection interface, mixing, volume control, and power on/off functions as the embodiment of FIG. 10.

Both the embodiments of FIG. 10 and FIG. 11 require a Sample Clock to synchronize the incoming audio sample data and subsequent units that operate on the data. The Sample Clock is generated by the Framing and Error Protection Decoder and Sample Clock Generator as shown in FIG. 1.

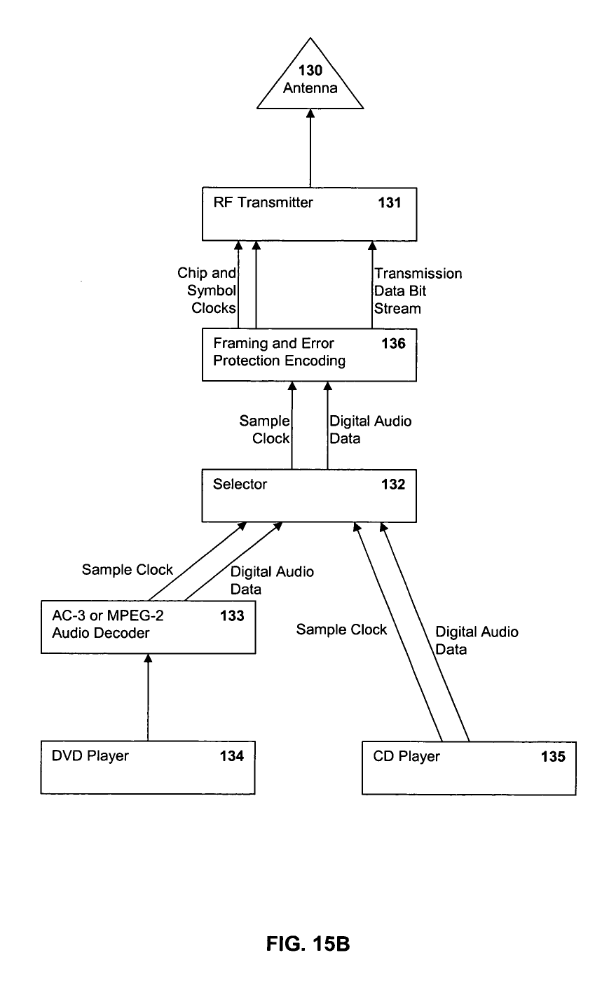

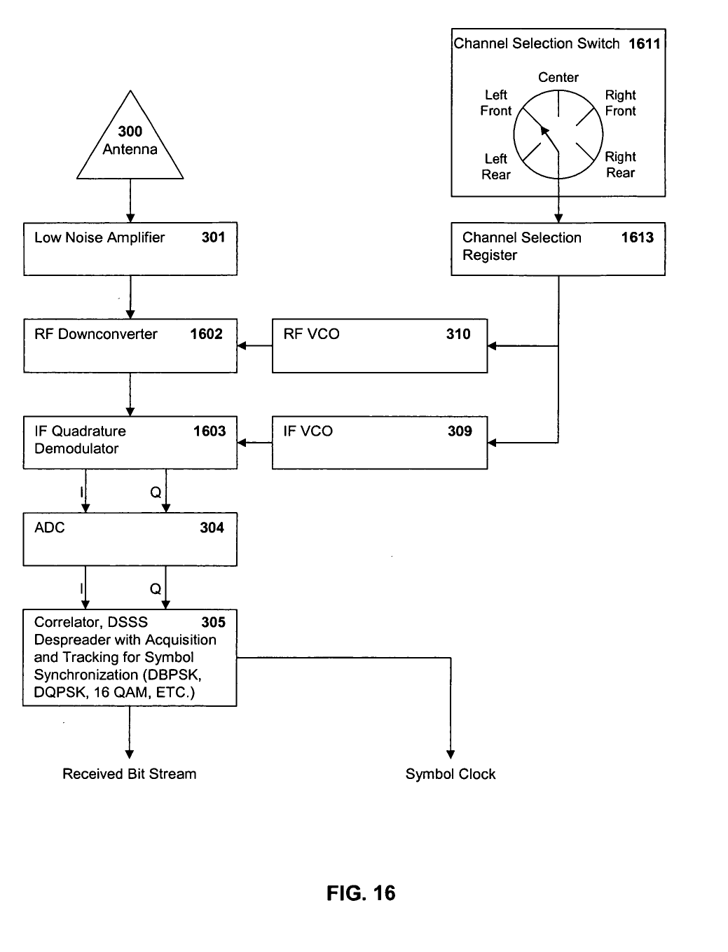

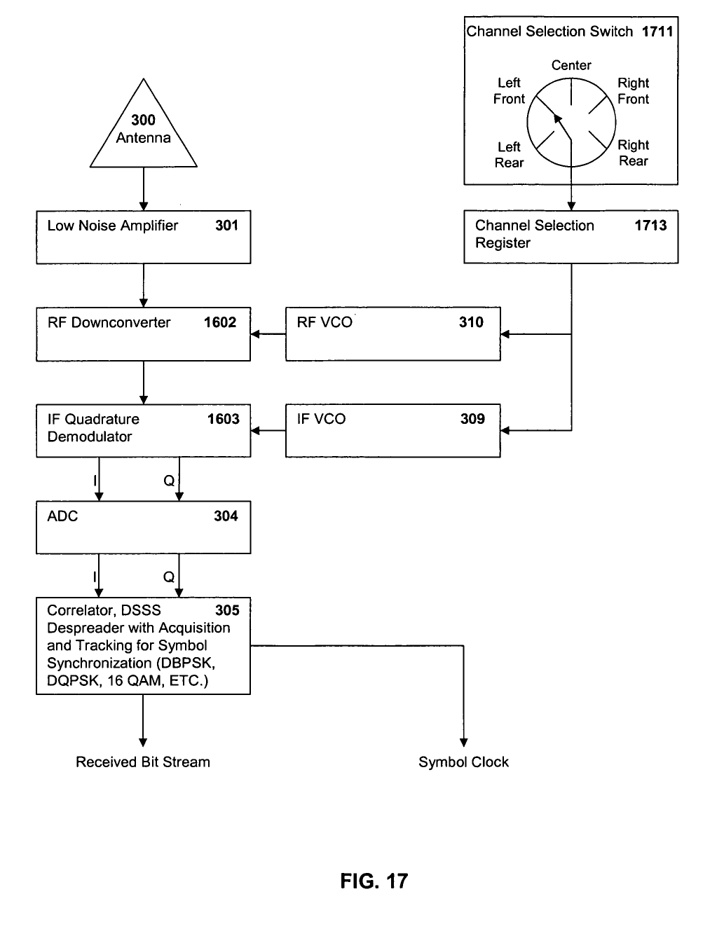

In the embodiment of FIG. 1, the function of channel selection is performed in the Digital to Speaker Input Conversion and Channel Selector unit 103,113,123. This corresponds to a Time Domain Multiple Access (TDMA) method of multiplexing the multiple audio channels onto a single RF frequency carrier. FIG. 15 shows another embodiment of the current invention. In this embodiment the function of channel selection is performed in the RF Receiver 1504,1514,1524 rather than in the Digital to Speaker Input Conversion Unit 1503,1513,1523. FIG. 16 shows one embodiment of the RF Receiver used in the embodiment of FIG. 15. Here the output of the Channel Selection Register 1613, whose value is set by the Channel Selection Switch 1611 sets the RF carrier frequency for the current loudspeaker. In this embodiment all loudspeakers receive on a different carrier frequency and the RF Transmitter 1531 transmits each audio channel on a separate carrier frequency. This corresponds to a Frequency Domain Multiple Access (FDMA) method of multiplexing the multiple audio channels. As shown in the embodiment of FIG. 16 the Channel Selection register sets the carrier frequency of both the RF Downconverter 1602 and IF Quadrature Demodulators 1603. In another embodiment only the carrier frequency of the IF Quadrature Demodulator 1603. FIG. 17 shows another embodiment of the RF Receiver used in embodiment of FIG. 15. In this embodiment, the Channel Selection Register 1713 sets the spreading code for the RF Receiver. This corresponds to a Code Division Multiple Access (CDMA) method of multiplexing the multiple audio channels. Corresponding to the RF Receiver embodiment of FIG. 17, the RF Transmitter 1531 transmits the multiple audio channels using different spreading codes.

In the embodiment of the present invention shown in FIG. 15 the Channel Selection Switch 1611,1711 is moved into the RF Receiver so that it can set the RF carrier frequency and subcarrier frequencies or the spreading code. This results in a new embodiment of the Digital to Speaker Input Conversion unit 1503, 1513, 1523. This embodiment is identical to the embodiments of Digital to Speaker Input Conversion and Channel Selector described above for FIG. 1, 103,113,123, except that a new embodiment of Channel Selector Interface is used. This Channel Selector Interface embodiment is shown in FIG. 19. It is the same as that for FIG. 18 except with no Channel Selection Switch. In this embodiment of the Channel Selector Interface no actual channel selection is performed, just status decoding and group selection switching, however the name is retained for continuity.

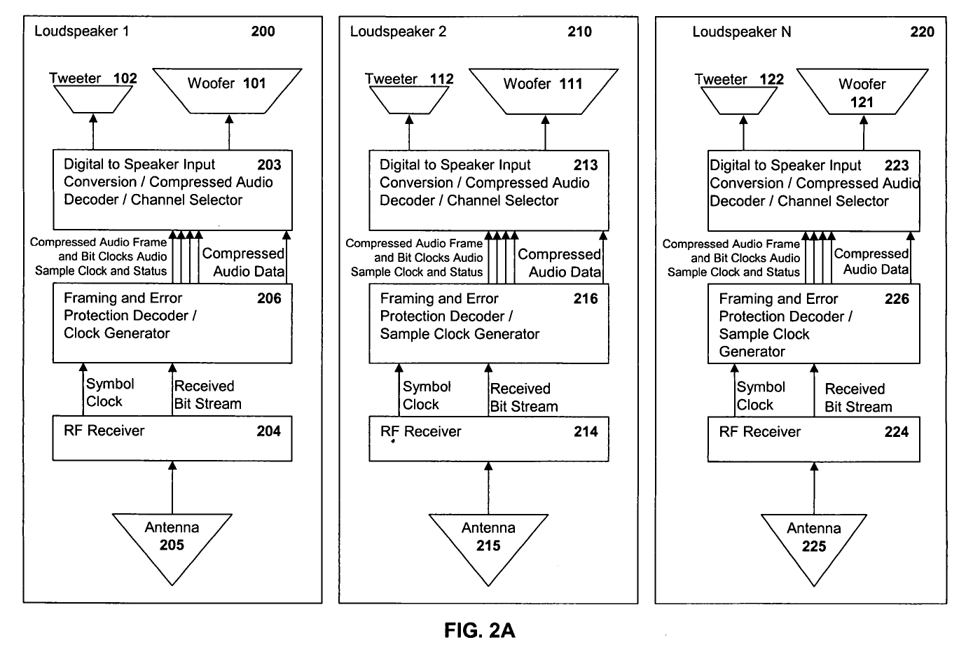

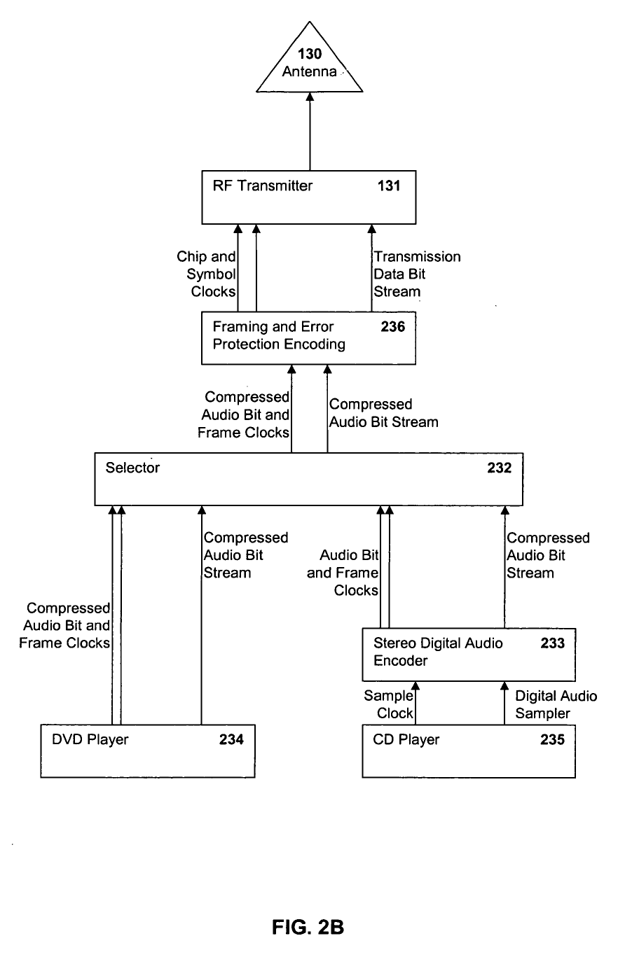

The block diagram of FIG. 2 shows another embodiment of the present invention. In this embodiment the digital audio sample stream is digitally compressed before it is transmitted through the air. At the loudspeaker the compressed digital audio sample stream is uncompressed and a single channel of uncompressed audio is output to the speaker. By transmitting digitally compressed audio the bit rate required for RF transmission is reduced, greatly simplifying the RF design.

Audio from the Compact Disk Player 235 is uncompressed stereo at 44100*2*16=1,411,200 bits/sec. Audio from the DVD Player 234 is multichannel compressed audio—for example, six channel Dolby AC-3 compressed audio, or eight channel MPEG-2 compressed audio. The compressed six or eight channel audio from the DVD disk has a composite bit rate of approximately 500,000 bits/second. The uncompressed stereo audio from the CD player, with a bit rate of 1411200 bits/second, is input to a Stereo Digital Audio Encoder 233 that compresses the audio to generate a bit stream of approximately 500,000 bits/second. Although the compressed CD audio is only a two channel signal it has the same bit rate as the compressed DVD audio with six or eight channels. The Stereo Digital Audio Encoder 233 uses a smaller compression factor than that used to generate the DVD compressed audio. This smaller compression factor allows for higher fidelity in the stereo audio stream and allows for simpler design in the Stereo Digital Audio Encoder 233.

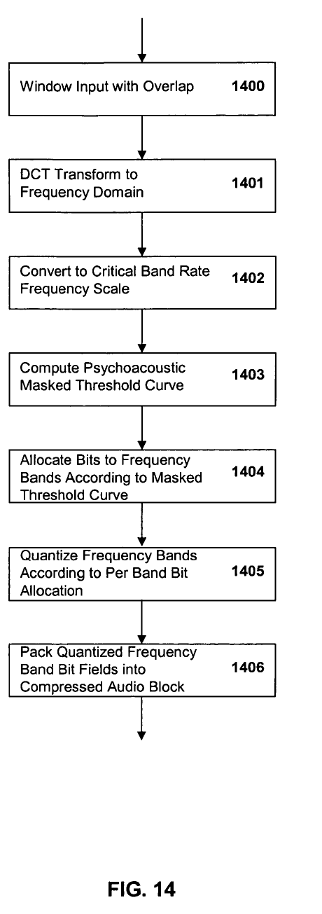

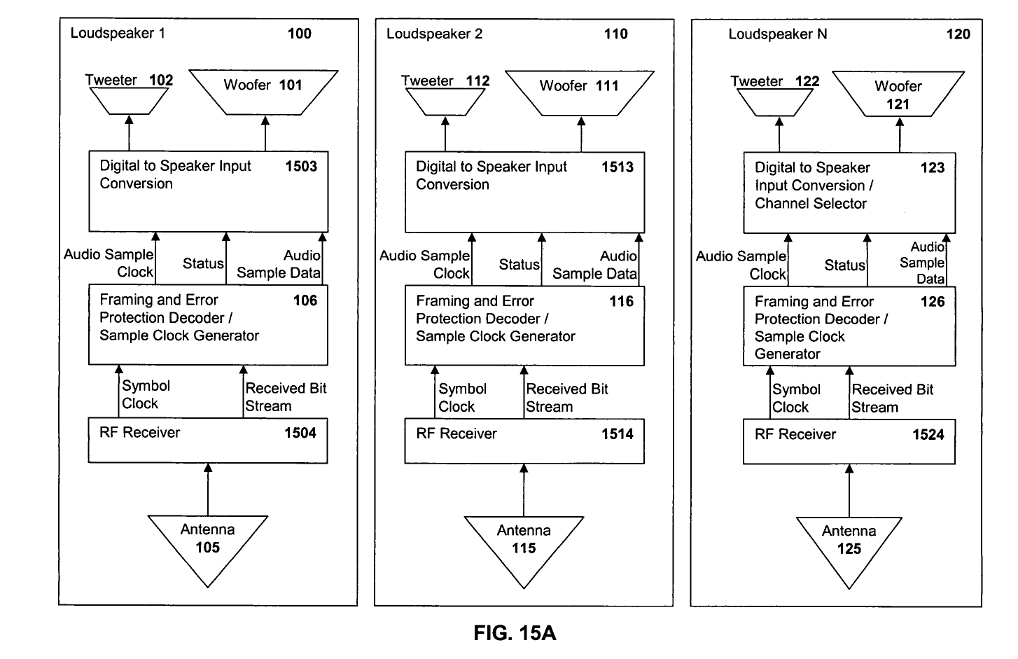

High fidelity digital audio compression such as AC-3 or MPEG-2 is performed in blocks. One block of digital audio samples at a time is used to generate a block of Compressed Digital Audio Data bits. AC-3 and MPEG-2 are perceptual audio coders. Perceptual audio coders are well known to those skilled in the art of high fidelity digital audio data compression. The Stereo Digital Audio Encoder 233 is such a perceptual encoder. FIG. 14 shows one embodiment of a single channel of the Stereo Digital Audio Encoder 233. The input stream of digital samples is taken in overlapping blocks. Each such block is multiplied by a tapered window 1400 such as a Hanning window. The windowed sample block is transformed to the frequency domain using a Discrete Cosine Transform 1401. The frequency scale is converted to a quasi-logarithmic critical band rate scale 1402. A psychoacoustic masked threshold curve is calculated for the frequency domain data 1403. It is well known that soft sounds with frequencies near those of louder sounds may be inaudible due to masking. The masked threshold curve is defines a frequency dependent level beneath which sounds are inaudible. The masked threshold curve is dependent on the frequency content of the input block. The number of compressed digital audio bits output for each digital audio input sample block is fixed. The input quasi-log spaced frequency bands of the input frequency domain block are arranged according to the relative audibility of their in-band energy. This audibility is determined with respect to the computed masked threshold curve. The fixed number of bits per compression block are allocated across the different frequencies 1404,1405 according to their relative audibility. Completely inaudible bands may receive zero allocated bits. Some bands may be encoded with 1-2 bits, others with 12 bits. The quantized frequency bands are backed into a single Compressed Digital Audio Frame 1406 for transmission to the loudspeaker.

Accompanying the blocks of Compressed Digital Audio Data are a bit clock and frame clock. The bit clock synchronizes individual bits in the compressed audio stream. The frame clock marks the boundaries between blocks of compressed audio. A fixed number of audio samples is specified as input to each compressed audio block and a fixed number of compressed audio bits is output each block. Therefore, there is a fixed frequency ratio between the input Digital Audio Sample Clock and the output Compressed Digital Audio Bit Clock and Compressed Digital Audio Frame Clock. For some methods, there may be a dynamic selection between a small number of different block sizes, but it will be obvious to one skilled in the art of high fidelity digital audio compressor design that this does not change the character of the present invention.

The Selector 232 selects between the two 500,000 bits/second Compressed Audio Data Streams along with their accompanying bit and frame clocks. The selected stream is passed to the Framing and Error Protection Encoding unit 236. A block diagram of the Framing and Error Protection Encoding unit is shown in FIG. 6. The functions in FIG. 6 are almost identical to those of FIG. 5 described earlier for the case of non-compressed audio. The differences are that the Compressed Digital Audio Bit Stream input to FIG. 6 is already divided into Compressed Digital Audio Frames whose boundaries are marked by the Compressed Digital Audio Frame Clock also input to FIG. 6. Since the frequency of the Compressed Digital Audio Bit Clock is a fixed ratio of the frequency of the Audio Sample Clock, and since the frequency Audio Sample Clock is a fixed ratio of the frequency of the Symbol and Chip Clocks, then the frequency of the Compressed Digital Audio Bit Clock is also a fixed ratio of the frequency of Symbol and Chip Clocks. This allows the Symbol and Chip Clocks in FIG. 6 to be generated by frequency multiplication and clock division of the Compressed Digital Audio Bit Clock. This is accomplished by the Chip Clock and Symbol Clock Generator 605 in a manner similar to that described for 505 of FIG. 5. The rest of the functions of FIG. 6 are the same as those for FIG. 5. The output of FIG. 6 is input to the same RF Transmitter described as FIG. 4.

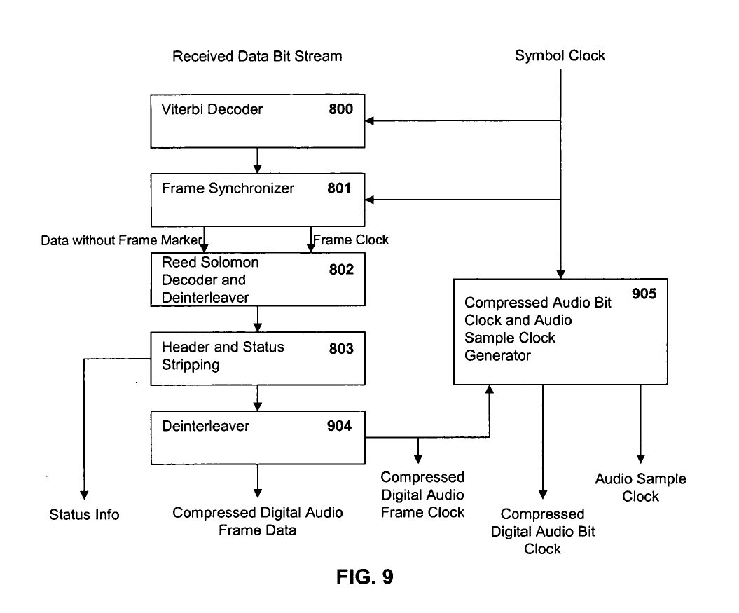

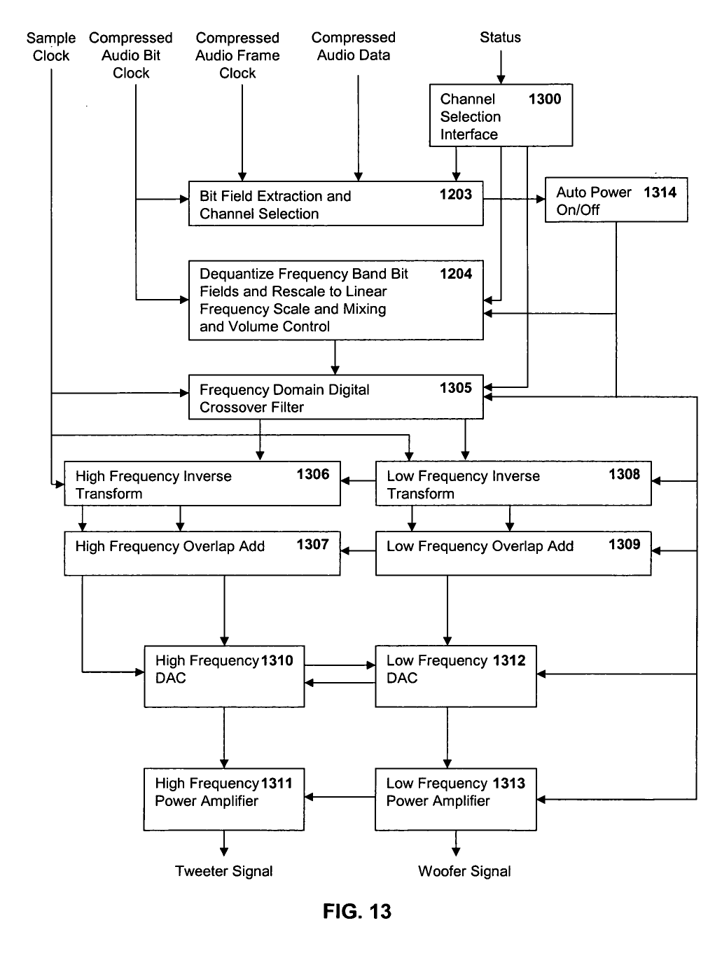

Just as in FIG. 1 each loudspeaker in 200,210,220 in has an Antenna 205,215,225 and RF Receiver 204,214,223 which are identical with those of FIG. 1. The output of the RF Receivers is input to the Framing and Error Protection Decoder and Clock Generator 206,216,226. A block diagram of the Framing and Error Protection Decoder and Clock Generator is shown in FIG. 9. The functions of FIG. 9 are mostly identical with the functions of FIG. 8 described for the non-compressed audio case. The difference is that the output of the Deinterleaver 904 is a bit stream consisting of Compressed Digital Audio Frame Data whose boundaries are marked by the Compressed Digital Audio Frame Clock which is also output from the Deinterleaver 904. The Compressed Audio Bit Clock and Audio Sample Clock Generater 905 functions much like its counterpart 805 in FIG. 8 except that in addition to regenerating the Audio Sample Clock it also regenerates the Compressed Digital Audio Bit Clock to synchronize the bits coming from the Deinterleaver. FIG. 13 shows another embodiment of the Digital to Speaker Input Conversion and Compressed Audio Decoder and Channel Selector unit.

In embodiment of FIG. 2, the output of the Framing and Error Protection Decoder and Clock Generator 206,216,226, consisting of Compressed Audio Frame and Bit Clocks Audio Sample Clock and Compressed Audio bit stream, is input to the Digital to Speaker Input Conversion and Compressed Audio Decoder and Channel Selector unit 203,213,223.

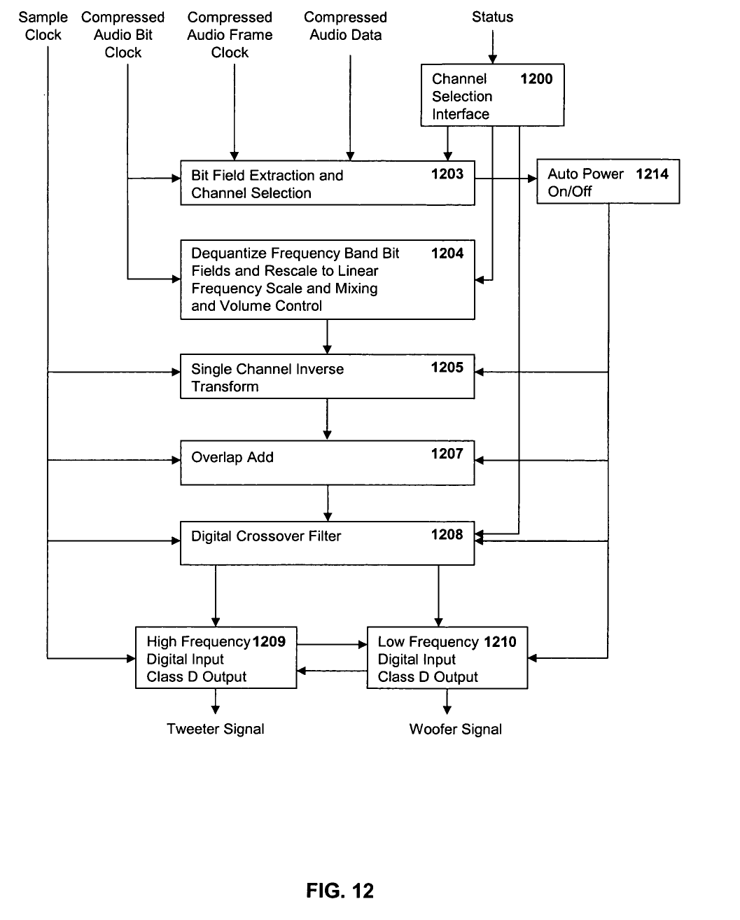

FIG. 12 shows a block diagram of the Digital to Speaker Input Conversion and Compressed Audio Decoder and Channel Selector unit. Each received frame of Compressed Digital Audio is input to the Bit Field Extraction and Channel Selection unit 1203. Here the quantized bit fields for each frequency band for each channel are identified. Only the bit fields for the selected channel or channels, according to the output of the Channel Selection Interface 1200, are selected. The Channel Selection Interface is identical to that shown in FIG. 18. The bit fields are dequantized and rescaled to the original linear frequency in the Dequantize Frequency Band Bit Fields and Rescale to Linear Frequency Scale and Mixing and Volume Control unit 1204. If the mixing mode specified by the Channel Selection Interface 1200 indicates a mix down of multichannel surround sound to stereo, then the Dequantize Frequency Band Bit Fields and Rescale to Linear Frequency Scale and Mixing and Volume Control unit 1204 also performs this mixing function in the frequency domain. The volume control function is also implemented in the frequency domain in 1204 based on status information received by the Channel Selection Interface 1200. The output of 1204 is a linear frequency domain data block which is inverse transformed 1205 to return to the time domain. The inverse transformed block is a windowed time domain block, the first half of which is overlap added 1207 with the second half of the previous time domain block to generate a new half output block of uncompressed audio sample data. Just as in the uncompressed embodiment of FIG. 11, the uncompressed time domain digital audio signal is split into high and low frequency bands by the digital crossover 1208, whose coefficient may be set by output from the Channel Selection Interface 1200, and the bands are sent to Class D digital input PWM amplifiers 1209, 1210 which generate signals for the Woofer and Tweeter. In another embodiment the Class D digital amplifiers 1209,1210 are replaced by DACs and analog power amplifiers as in FIG. 10.

FIG. 13 shows another embodiment of the Digital to Speaker Input Conversion and Compressed Audio Decoder and Channel Selector unit. In this embodiment the digital crossover function is implemented as a Frequency Domain Digital Crossover 1305 before the data is inverse transformed to the time domain. This is a particular economical implementation of the crossover function. Crossover coefficient, this time in the frequency domain, can be set by the Channel Selection Interface 1300. The frequency domain digital crossover results in separate frequency domain data blocks for the high frequency and low frequency bands. These blocks are separately inverse transformed 1306,1308 and overlap added 1307,1309 two generate the high and low frequency digital time domain signals which are input to the high and low frequency DACs 1310,1312 and then the high and low frequency power amplifiers 1311,1313. The DACs and power amplifiers of FIG. 13 can be replaced by Class D digital input amplifiers as in FIG. 12.

The embodiments of FIG. 12 and FIG. 13 have the same auto power on/off embodiments as those of FIG. 10 described earlier.

The embodiments of FIG. 12 and FIG. 13 require a Compressed Audio Frame Clock, a Compressed Audio Bit Clock, and an uncompressed Sample Clock to synchronize the incoming compressed audio sample data and later the uncompressed sampled data. These clocks are generated by the Framing and Error Protection Decoder and Clock Generator as shown in.

In the embodiments of FIG. 12 and FIG. 13 the volume control function is implemented in the Dequantize Frequency Band Bit Fields and Rescale to Linear Frequency Scale and Mixing and Volume Control unit. As with FIG. 10 the volume control function can be moved to any of the digital audio processing blocks in FIG. 12 and FIG. 13 without changing the character of the present invention.

In both the uncompressed and compressed embodiments of FIG. 1 and FIG. 2, the RF Receivers in each loudspeaker are designed to function in one of the unlicensed Instrumentation, Scientific, and Medical (ISM) frequency bands defined by the FCC in the U.S. These bands are centered around 900 MHz, 2.4 GHz, and 5.7 GHz. Internationally 900 MHz is not available for this type of product. Whatever transmission frequency band is used the important thing is that the bandwidth be sufficient to support the transmitted bit streams as described above. It is obvious to one skilled in the art that almost any transmission band can, in theory, be used for this purpose as long as the bandwidth is sufficient. In particular, embodiments for different countries will no doubt use different transmission bands.

In all of the embodiments of the present invention discussed above that use digital audio data compression, reference has been made to AC-3 and MPEG-2 perceptual audio encoding and decoding. AC-3 and MPEG-2 are two important embodiments of perceptual encoders, but it is obvious to one skilled in the art of perceptual encoder and decoder design that any perceptual audio coder can be used in the current invention without changing the character of the invention. What's more, it is not necessary to use a perceptual audio coder in the present invention. In some applications a simpler time domain audio coder, such as an ADPCM or linear predictive coder, might be used. With suitable framing for error correction and detection, these simpler coders may be used without changing the character of the present invention.

What is claimed is:

1. A discrete speaker for use in a distributed digital wireless loudspeaker system having at least two discrete speakers and a single receiver for transmitting an RF signal including a transmission clock and at least two audio channels of transmission data, the speaker comprising:
means for receiving the RF signal,
means for generating a derived sample clock based upon the transmission clock,
means for selecting one of the audio channels from the RF signal for broadcast,
means for generating an output audio signal based upon the selected audio channel, and
means for broadcasting sound based upon the selected audio channel.

2. The speaker of claim 1 wherein the received RF signal further includes status data.

3. The speaker of claim 2, further comprising means, responsive to a control signal in the status data, for selectively activating the speaker.

4. The speaker of claim 2, further comprising means for responding to a control signal in the status data operable for controlling volume of the broadcast sound.

5. The speaker of claim 2, further comprising means for responding to a control signal in the status data operable for controlling equalization of the broadcast sound.

6. The speaker of claim 1, wherein the receiver receives two RF signals at two different frequencies, each RF signal including one of the audio channels.

7. The speaker of claim 1, wherein the RF signal further includes a channel of status data.

8. The speaker of claim 7, wherein the two channels of audio transmission data and the status channel are multiplexed prior to transmission, and the speaker further includes means for demultiplexing the received RF signal.

9. The speaker of claim 2, further comprising means, responsive to a control signal in the status data for assigning the speaker to a speaker group, for selectively activating the speaker based on the speaker group to which the speaker is assigned.

10. The speaker of claim 1 wherein the RF signal includes frame markers and the speaker further comprises means, responsive to the frame markers, for synchronizing the sound broadcast by the speaker with the sound broadcast by each other speaker in the wireless loudspeaker system.

11. Cancelled

12. Cancelled

13. Cancelled

14. A discrete speaker for use in a distributed digital wireless loudspeaker system having at least two discrete speakers and a single receiver for transmitting an RF signal including at least two audio channels of transmission data, the speaker comprising:
means for receiving the RF signal including the at least two audio channels of transmission data,
means for selecting one of the audio channels of transmission data,
means for generating output audio data based upon the selected audio channel, and
means for broadcasting sound based upon the selected audio channel.

15. The speaker of claim 14 wherein the received RF signal includes status data.

16. The speaker of claim 15, further comprising means, responsive to a control signal in the status data, for selectively activating the speaker.

17. The speaker of claim 15, further comprising means, responsive to a control signal in the status data, for controlling volume of the broadcast sound.

18. The speaker of claim 15, further comprising means, responsive to a control signal in the status data, for controlling equalization of the broadcast sound.

19. The speaker of claim 14 further comprising means, responsive to a control signal in the status data for assigning the speaker to a speaker group, for selectively activating the speaker based on the speaker group to which the speaker is assigned.

20. The speaker of claim 14 wherein the RF signal includes frame markers, and the speaker further comprises means, responsive to the frame markers, for synchronizing the speaker with the sound broadcast by each other speaker in the wireless loudspeaker system.

21. Cancelled

22. Cancelled

23. Cancelled

24. A discrete speaker for use in a distributed digital wireless loudspeaker system having at least two discrete speakers and a single receiver for transmitting an RF signal including at least two audio channels of transmission data and frame markers appearing at predetermined intervals in the RF signal, the speaker comprising:
means for receiving the RF signal
means for selecting one of the audio channels of the received RF signal,
means for generating an output audio signal based upon the selected audio channel,
means, responsive to the frame markers, for synchronizing the output audio signal with the output audio signal of each other speaker in the wireless loudspeaker system, and
means for broadcasting sound based upon the synchronized output audio signal.

25. The speaker of claim 24 wherein the received RF signal includes status data.

26. The speaker of claim 25, further comprising means, responsive to a control signal in the status data, for activating the wireless speaker.

27. The speaker of claim 25, further comprising means, responsive to a control signal in the status data, for controlling volume of the broadcast sound.

28. The speaker of claim 25, further comprising means, responsive to a control signal in the status data, for controlling equalization of the broadcast sound.

29. The speaker of claim 24, wherein the receiver receives two RF signals at two different frequencies, each RF signal including one of the transmission channels.

30. The speaker of claim 24, wherein the RF signal includes a channel of status data and the two channels of audio transmission data and the status channel are multiplexed prior to transmission, the speaker further comprising means for demultiplexing the received RF signal.

31. The speaker of claim 24, further comprising means, responsive to a control signal in the status data for assigning the speaker to a speaker group, for selectively activating the speaker based on the speaker group to which the speaker is assigned.

32. A discrete speaker for use in a distributed digital wireless loudspeaker system having at least two discrete speakers and a single receiver for transmitting an RF signal including at least two audio channels of transmission data and status data, the speaker comprising:
means for receiving the RF signal
means for selecting one of the audio channels of the received RF signal,
means for generating an output audio signal based upon the selected channel and the status data,
means for broadcasting sound based upon the output audio signal and the status data.

33. The speaker of claim 32, comprising means, responsive to a control signal for assigning the speaker to a speaker group, for selectively activating the speaker based on the speaker group to which the speaker is assigned.

34. The speaker of claim 32, wherein the RF signal includes frame markers, and the speaker further comprises means, responsive to the frame markers, for synchronizing the sound broadcast by the speaker with sound broadcast with each other speaker in the wireless loudspeaker system.

35. Cancelled

36. Cancelled

37. Cancelled

38. A discrete speaker for use in a distributed digital wireless loudspeaker system having at least two discrete speakers and a single receiver for transmitting an RF signal including at least two multiplexed audio channels of transmission data, the speaker comprising:
means for receiving the RF signal
means for demultiplexing the received RF signal,
means for selecting one of the audio channels from the demultiplexed signal,
means for generating an output audio signal based upon the selected audio channel, and
means for broadcasting sound based upon the output audio signal.

39. The speaker of claim 38, wherein the RF signal further includes status data.

40. The speaker of claim 39, further comprising means, responsive to a control signal in the status data, for activating the wireless speaker.

41. The speaker of claim 39, further comprising means, responsive to a control signal in the status data, for controlling volume of the broadcast sound.

42. The speaker of claim 39, further comprising means, responsive to a control signal in the status data, for controlling equalization of the broadcast sound.

43. The speaker of claim 39, further including means, responsive to a control signal in the status data for assigning the speaker to a speaker group, for selectively activating the speaker based on the speaker group to which the speaker is assigned.

44. The speaker of claim 38, wherein the RF signal includes frame markers, and the speaker further comprises means, responsive to the frame marker for synchronizing the sound broadcast by the speaker with sound broadcast with each other speaker in the wireless loudspeaker system.

45. Cancelled

46. Cancelled

47. Cancelled

48. The speaker of claim 1, the means for generating a derived sample clock comprising means for obtaining a direct sequence spread spectrum chip clock having a rate equal to an integer multiple of a rate of an audio sample clock.
